(19) United States
(12) Patent Application Publication
(10) Pub. No.: US 2013/0278939 A1
(43) Pub. Date: Oct. 24, 2013

(54) APPARATUS FOR NON-INCREMENTAL POSITION AND FORM MEASUREMENT OF MOVING SOLD BODIES

(71) Applicants: Thorsten Pfister, Freiburg (DE); Lars Buettner, Dresden (DE); Juergen Czarske, Dresden (DE); Florian Dreier, Dresden (DE)

(72) Inventors: Thorsten Pfister, Freiburg (DE); Lars Buettner, Dresden (DE); Juergen Czarske, Dresden (DE); Florian Dreier, Dresden (DE)

(73) Assignee: TECHNISCHE UNIVERSITÄT DRESDEN, DRESDEN (DE)

(21) Appl. No.: 13/990,499

(22) PCT Filed: Sep. 15, 2011
(86) PCT No.: PCT/DE11/01762

§ 371 Date: May 30, 2013

(30) Foreign Application Priority Data
Nov. 30, 2010 (DE) 10 2010 053 726.8

(51) Int. Cl. G01B 11/14

(52) U.S. Cl. CPC G01B 11/14
USPC 356/601

(57) ABSTRACT

The invention relates to an apparatus (1) for non-incremental position and form measurement of moving solid bodies (7), containing a laser Doppler distance sensor (10) in wavelength multiplexing technique with at least two different wavelengths (λ1, λ2) and with a modular fibre optic measurement head in its sensor design, which contains two additional modules, which are connected to the measuring head by means of fibre optics a light source unit (2) and a detection unit (4). Two laser light bundles (37) of different wavelengths (λ1, λ2) in the light source unit (2) are coupled into a glass fibre (24). The bichromatic scattered light in the detection unit (4) is split into the different wavelengths (λ1, λ2) corresponding to the two measurement channels (41, 42) and subsequently are detected separately by means of two photo detectors (43, 44).

The invention relates to an apparatus for non-incremental position and form measurement of moving solid bodies for process measurement, with the apparatus containing a laser Doppler distance sensor in wavelength multiplex technique with at least two different wavelengths λ₁, λ₂ and a modular, fibre optic measurement head in its sensor design, with the sensor design of the laser Doppler distance sensor containing two additional modules, which are connected to the measuring head by means of fibre optics:

a light source unit and a detection unit,
with two laser light bundles of different wavelengths λ₁, λ₂ in the light source unit
at least being coupled into a glass fibre,
with the bichromatic scattered light in the detection unit being split into the different wavelengths λ₁, λ₂ corresponding to the two measurement channels and subsequently being detected separately by means of two photo detectors, and
with the detection unit being connected to an evaluation unit, in which the signal evaluation is carried out according to the principle of the laser Doppler distance sensor for determination of position, speed and form of the solid body.

The precise, contact-less and absolute position and form measurement of moving solid bodies is an important task, especially in monitoring of turbomachinery. The improvement of the operational safety, the service life and particularly the energy efficiency of motors and turbomachinery, such as electric motors, aircraft engives, generators or gas and steam turbines is of great interest, not least from an ecological perspective. In this context skills in and knowledge of rotor dynamics is of vital importance to be able to minimize losses and wear. Due to the extreme environmental conditions (high temperatures, pressure fluctuations, vibrations, electromagnetic fields) and the high speeds reaching the ultrasound range involved, however, there are hardly any suitable measurement methods to measure dynamic rotor deformations and blade vibrations during operation in a precise manner and with the high time resolution required to date. Furthermore, smallest possible miniature sensors are required here, which have to be robust and temperature-resistant at the same time.

For tip clearance and vibration measurements in turbomachinery capacitive or inductive sensors are used as a standard. These are described in the publications A. G. Sheard, S. G. O'Donnell, J. F. Stringfellow: High Temperature Proximity Measurement in Aero and Industrial Turbomachinery, Journal of Engineering Gas Turbines and Power 121, p. 167-173, 1999, T. Fabian, F. B. Prinz, G. Brasseur: Capacitive sensor for active tip clearance control in a palm-sized gas turbine generator, IEEE Trans. Instrum. Meas. 54, p. 1133-43, 2005, A. Steiner: Techniques for blade tip clearance measurements with capacitive sensors, Meas. Sci. Technol. 11, p. 865-9, 2000, C. Roeseler, A. Flotow and P. Tappert: Monitoring blade passage in turbomachinery through the engine case (no holes), Proc. IEEE Aerospace Conf., Vol 6, p. 6-3125-29, 2002 and C. P. Lawson, P. C. Ivey: Turbomachinery Blade Vibration Amplitude Measurement through Tip Timing with Capacitance Tip Clearance Probes, Sensor and Actuators A, Vol 118, p. 14-24, 2005. However, in practice, with (50 . . . 100) μm they reveal a relatively high measurement uncertainty and are thus not suitable for active tip clearance control as described in the publications A. G. Sheard, S. G. O'Donnell, J. F. Stringfellow: High Temperature Proximity Measurement in Aero and Industrial Turbomachinery, Journal of Engineering Gas Turbines and Power 121, p. 167-173, 1999 as well as S. B. Lattime, B. M. Steinetz: High-Pressure-Turbine Clearance Control Systems: Current Practices and Future Directions, Journal of Propulsion and Power 20, p. 302-311, 2004.

Moreover, just like eddy current sensors, these sensors are unsuitable for many applications due to electromagnetic interferences. In addition, capacitive tip clearance sensors require a high level of calibration. Furthermore, both, capacitive and inductive sensors and eddy current sensors fail for non-metallic measurement objects, such as novel turbine blades made of ceramic, plastic or fibre composites.

For dynamic deformation and vibration measurements strain gauges are commonly used as described in the publications A. Kempe, S. Schlamp, T. Rösgen: Low-coherence interferometric tip-clearance probe, Opt. Lett. 28, p. 1323-5, 2003, A. Kempe, S. Schlamp, T. Rösgen, K. Haffner: Spatial and Temporal High-Resolution Optical Tip-Clearance Probe for Harsh Environments, Proc. 13th Int. Symp. on Applications of Laser Techniques to Fluid Mechanics (Lisbon, Portugal, 26-29 Jun. 2006), article no. 1155, 2006 and R. G. Dorsch, G. Häusler, and J. M. Herrmann: Laser triangulation: fundamental uncertainty in clearance measurement, Appl. Opt. 33, p. 1306-1314, 1994, although their durability, their application and the signal transmission from the rotating system involves great effort and significant difficulties.

Optical methods are fast and contact-less and inherently provide a high resolution due to the small laser wavelength. However, the measurement rate of most optical distance sensors is restricted to few kHz either due to mechanical scan processes (TD-OCT, autofocus sensor) according to the publications A. Kempe, S. Schlamp, T. Rösgen: Low-coherence interferometric tip-clearance probe, Opt. Lett. 28, p. 1323-5, 2003 and A. Kempe, S. Schlamp, T. Rösgen, K. Haffner: Spatial and Temporal High-Resolution Optical Tip-Clearance Probe for Harsh Environments, Proc. 13th Int. Symp. on Applications of Laser Techniques to Fluid Mechanics (Lisbon, Portugal, 26-29 Jun. 2006), article no. 1155, 2006 or due to the readout time and the maximum picture frequency of the detectors used (FDOCT, triangulation, fringe projection, chromatic confocal sensor) according to the publications R. G. Dorsch, G. Häusler, and J. M. Herrmann: Laser triangulation: fundamental uncertainty in clearance measurement, Appl. Opt. 33, p. 1306-1314, 1994, J. P. Barranger, M. J. Ford, 1981: Laser-optical blade tip clearance measurement system, J. Eng. Power 103, p. 457-60, 1981, Y. Matsuda, T. Tagashira: Optical blade-tip clearance sensor for non-metal gas turbine blade, J. Gas Turbine Soc. Japan (GTSJ) 29, p. 479-84, 2001 and E. Shafir and G. Berkovic: Expanding the realm of fiber optic confocal sensing for probing position, displacement, and velocity, Appl. Opt. 45, p. 7772-7777, 2006, so that precise dynamic measurements on fast moving rotors are impossible. Laser Doppler vibrometers as described in the publication A. J. Oberholster, P. S. Heyns: Online condition monitoring of axial-flow turbomachinery blade-s using rotor-axial Eulerian laser Doppler vibrometry, Mechanical Systems and Signal Processing, Vol. 23, p. 1634-1643, 2009

are also unsuitable for use due to their incremental measuring method as these do no longer deliver a clear result in case of leaps in the object clearance or the surface form of more than half a wavelength of light (e.g. for coarse surfaces or from one turbine blade to the next).

With the laser Doppler distance sensor, which is a further development of the conventional laser Doppler velocimetry (LDV) and is described in the publications T. Pfister: Untersuchung neuartiger Laser-Doppler-Verfahren zur Positions-und Formvermessung bewegter Festkörperoberflächen, Shaker Verlag, Aachen, 2008, T. Pfister, L. Büttner, J. Czarske: Laser Doppler profile sensor with sub-micrometre position resolution for velocity and absolute radius measurements of rotating objects, Meas. Sci. Technol. 16, p. 627-641, 2005, J. Czarske, L. Büttner, T. Pfister: Laser-Doppler-Distanzsensor und seine Anwendungen, Photonik May 2008, p. 44-47, T. Pfister, L. Büttner, J. Czarske, H. Krain, R. Schodl: Turbo machine tip clearance and vibration measurements using a fibre optic laser Doppler position sensor, Meas. Sci. Technol. 17, p. 1693-1705, 2006 and DE 10 2004 025 801 A1 these problems of conventional sensors could be overcome. The essential characteristic of the laser Doppler distance sensor is that this sensor simultaneously provides a high time resolution and measurement rate and micrometer precision, as in contrast to other distance sensors its measurement certainty is in general independent from the object speed. Therefore, precise measurements are also possible on fast moving or rotating objects. The laser Doppler distance sensor has been successfully tested on rotors and turbomachinery. However, size and temperature resistance have presented a problem in the past. In previous measurements on turbomachinery the sensor was cooled with water to protect it against the high temperatures, which in practice is undesirable and partly impossible due to the effort. Furthermore, the size of previous versions of the laser Doppler distance sensor is so large that the sensor in its previous form cannot be integrated in the housing of turbomachinery.

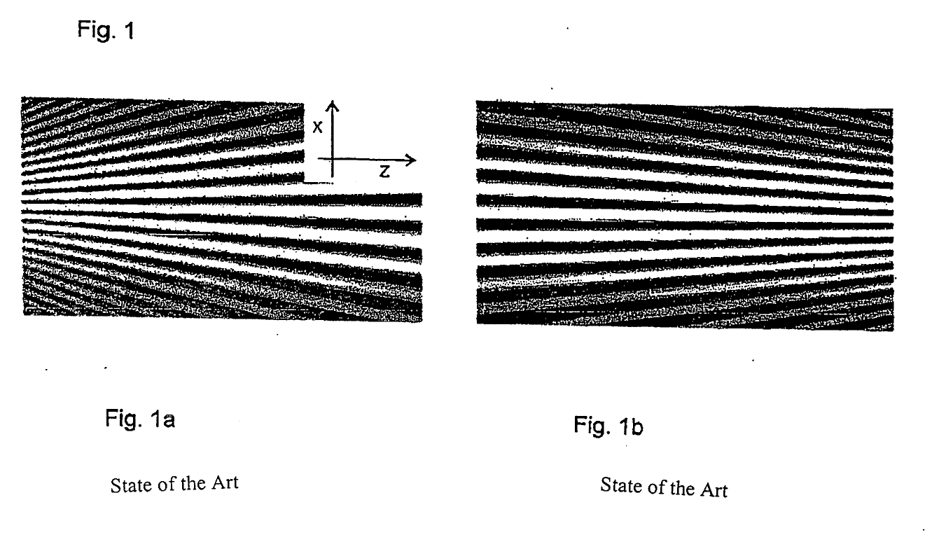

The implementation is based on the laser Doppler distance sensor the functional principle of which is described in the publications T. Pfister: Untersuchung neuartiger Laser-Doppler-Verfahren zur Positions-und Formvermessung bewegter FestkÖrperoberflächen, Shaker Verlag, Aachen, 2008, T. Pfister, L. Büttner, J. Czarske: Laser Doppler profile sensor with sub-micrometre position resolution for velocity and absolute radius measurements of rotating objects, Meas. Sci. Technol. 16, p. 627-641, 2005, J. Czarske, L. Büttner, T. Pfister: Laser-Doppler-Distanzsensor und seine Anwendungen, Photonik May 2008, p. 44-47 and T. Pfister, L. Büttner, J. Czarske, H. Krain, R. Schodl: Turbo machine tip clearance and vibration measurements using a fibre optic laser Doppler position sensor, Meas. Sci. Technol. 17, p. 1693-1705, 2006 as well as DE 10 2004 025 801 A1 and which is based on the generation of two fringe systems superimposed in a shared measurement volume of which at least one is fan-shaped. Ideally both systems are fan-shaped with opposite orientations: A convergent fringe system according to FIG. 1b, in which the fringe spacing continuously decreases along the z axis (corresponds to the optical axis) and a divergent fringe system according to FIG. 1a, in which the fringe spacing accordingly continuously increases.

The fringe systems are each described by a fringe spacing function d₁(z) and d₂(z).

The convergence or the divergence of the fringes is reached by making use of the wavefront curvature of the laser beams. For this purpose the beam waist of the Gaussian beam is placed upstream of the measurement volume to generate a diverging fringe system. Conversely, the adjustment of the beam waist down-stream of the measurement volume results in a converging fringe system. The two fringe systems must be physically distinguishable, which can be achieved, for example, by means of different laser wavelengths (wavelength multiplexing), carrier frequencies (frequency multiplexing) etc.

If a scattering object passes through the measurement volume, the scattered light can be separated from both systems and allocated to these so that two Doppler frequencies f₁ and f₂ can be determined. The quotient of these two Doppler frequencies

$$q ( z ) = \frac{{f}_{2} ( {v}_{x} , z )}{{f}_{1} ( {v}_{x} , z )} = \frac{{v}_{x} ( z ) / {d}_{2} ( z )}{{v}_{x} ( z ) / {d}_{1} ( z )} = \frac{{d}_{1} ( z )}{{d}_{2} ( z )} \qquad ( I )$$

does no longer depend on the scattering object speed vₓ and can thus be used as calibration function for determination of the axial position z of the scattering object within the measurement volume. This represents a step forward compared to the conventional LDV. By means of the known passage position z of the scattering object through the measurement volume the current fringe spacings (z) and d₂(z) can be determined from the fringe spacing trends known from the previous sensor calibration. Together with the two Doppler frequencies the scattering object speed then adds up to

vₓ(z)=f₁(vₓ,z)d₁(z)=f₂(vₓ,z)d₂(z) (II)

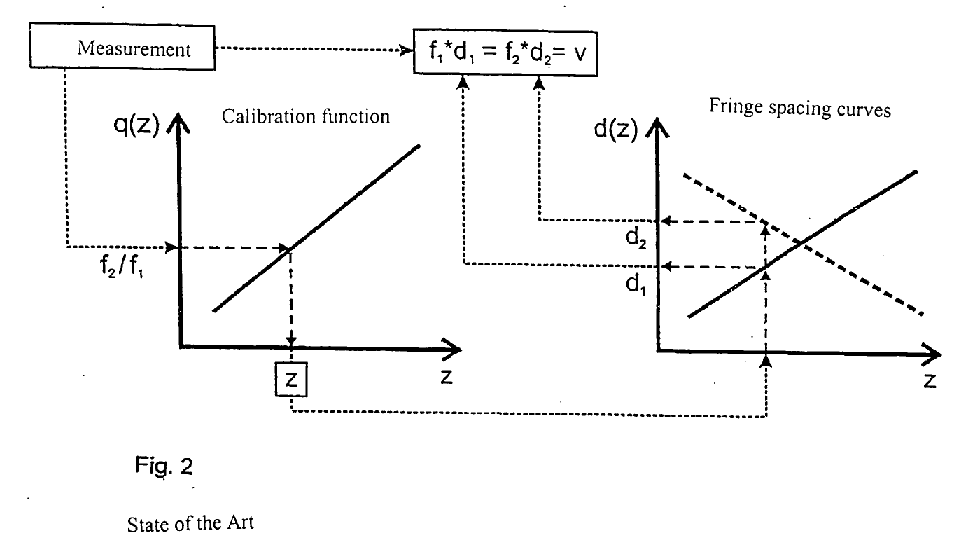

FIG. 2 depicts schematics of the functional principle of the laser Doppler distance sensor and discloses how the absolute axial object position z can be determined from the measured Doppler frequencies f₁ and f₂ independent from the lateral object speed vₓ measured in addition.

Hence, as for rotating objects the tangential speed and the radial position of the object surface is simultaneously determined depending on the circumferential angle, the laser Doppler distance sensor allows to determine the absolute 2D form of rotating solid bodies with submicrometer resolution according to DE 10 2004 025 801 A1. Due to the non-incremental measurement principle absolute position and form measurement is also possible for abrupt radius changes as occurring with bladed rotors between the individual rotor blades.

The essential characteristic of the laser Doppler distance sensor is that in contrast to conventional distance sensors its measurement uncertainty is inherently independent from the object speed so that a high measurement rate reaching the MHz range and a high position resolution reaching the submicrometer range can be achieved simultaneously. Hence, the laser Doppler distance sensor is predestined for precise and time-resolved measurement of deformation and vibrations of fast rotating components (rotating components, shafts, rotors of motors and turbomachinery). This has already been successfully demonstrated by means of test measurements on a transonic centrifugal compressor of the German Aerospace Center (DLR) for speeds up to 50,000 rpm and circumferential speeds up to 600 m/s as described in the publications T. Pfister, L. Büttner, J. Czarske, H. Krain, R. Schodl: Turbo machine tip clearance and vibration measurements using a fibre optic laser Doppler position sensor, Meas. Sci. Technol. 17, p. 1693-1705, 2006, L. Büttner, T. Pfister, J. Czarske: Fiber optic laser Doppler turbine tip clearance probe, Optics Letters 31, p. 1217-1219, 2006 and P. Günther, F. Dreier, T. Pfister, J. Czarske, T. Haupt, W. Hufenbach: Measurement of radial expansion and tumbling motion of a high-speed rotor using an optical sensor system, Mechanical Systems and Signal Processing, article in press, doi: 10.1016/j.ymssp.2010.08.005, 2010.

For the physical distinction of the two fringe systems multiplexing techniques are required, with both, wavelength multiplexing and frequency and time multiplexing having been successfully applied. The relevant multiplexing techniques require different sensor designs with more or less miniaturisation potential. To date three design implementations are known.

### First Design Implementation

A first design implementation, which can also be used for commercial LDV sensors is mainly used for sensor designs with frequency multiplexing. A fibre optic measurement head with four transmitting fibres is used for the four partial beams of the two fringe systems in total of the laser Doppler distance sensor, which are collimated by means of separate optics and then directed to a shared crossing point. This can be made by means of a shared front lens or by means of separate optics for the four transmitting beams. In addition an additional glass fibre or optical system is required for detection of scattered light so that a total of five separate glass fibres must be supplied to the measurement head.

In principle, such measurement head can be used for all known multiplexing techniques (wavelength, polarisation, frequency and time multiplexing) and there are possibilities to miniaturise this measurement head. The problem, however, is that particularly the four transmitting techniques must be aligned with each other and adjusted very precisely, which involves a high level of mechanical effort and sets limits to the miniaturisation. Furthermore, mechanical interferences and particularly temperature changes are a major problem with such a measurement head since they cause the alignment of the four transmitting optics to each other to change so that in the worst case the four transmitting beams do no longer cross at all making measurement entirely impossible. Hence, this design implementation does not only set limits to the miniaturisation, but cannot be used especially in high temperatures or under harsh environmental conditions at all or only with considerable technical effort.

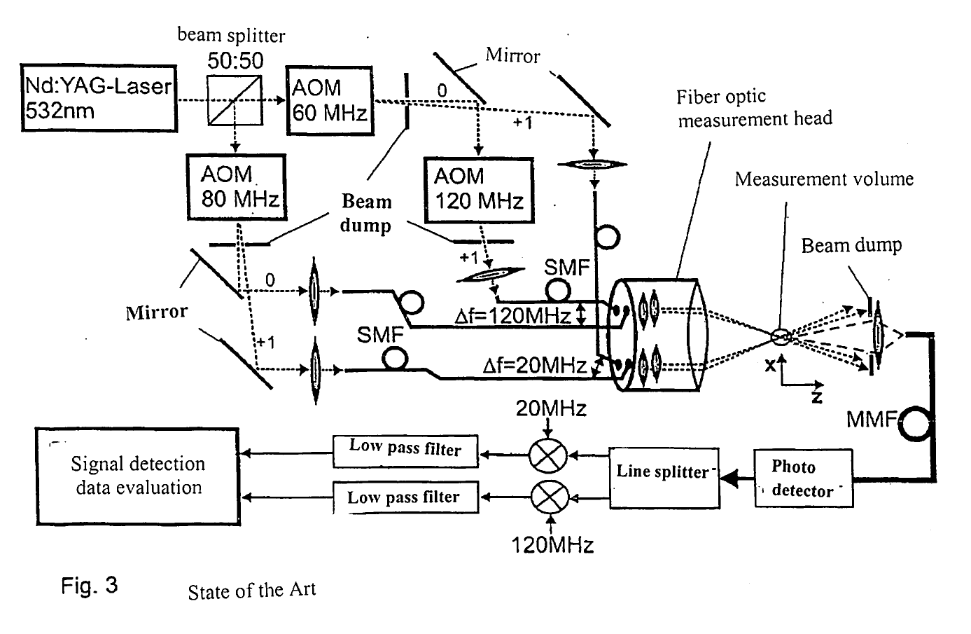

However, for a design of the laser Doppler distance sensor by means of frequency multiplexing there is no alternative to such design implementation with five separate beam paths (whether fibre-coupled or not). The resulting overall measurement device, which is described in the publication T. Pfister, L. Büttner, K. Shirai, J. Czarske: Monochromatic heterodyne fiber-optic profile sensor for spatially resolved velocity measurements with frequency division multiplexing, Applied Optics, Vol. 44, No. 13, p. 2501-2510, 2005, is shown in FIG. 3. A laser beam is divided into four partial beams with a frequency shift from 0 to 120 MHz by means of acousto-optical modulators (AOMs) and a beam splitter cube and coupled into single-mode fibres with collimation lenses. The individual partial beams are collimated in a fibre optic measurement head by means of separate optics and are made to cross in the measurement volume by means of a shared front lens. For detection of the scattered light from the measurement object another optical system with multi-mode fibre is provided, which can be integrated in the measurement head and maps the scattered light to a photodetector. The electric output signal of the photo detector is divided by means of a power splitter and down-sampled to the baseband with the carrier frequencies of the two measurement channels. To avoid aliasing effects and to eliminate undesirable frequency components the two resulting baseband signals are filtered by a low-pass filter.

As already mentioned above, the measurement head used requires a high adjustment effort and the resistance against vibrations or temperature gradients is problematic. As an alternative, integration of the overall transmitting optics including AOMs in the measurement head could be made without the use of fibre optics, which would make everything even more complex. Therefore, in general, the use of frequency multiplexing for the design of a robust miniature measurement head for the laser Doppler distance sensor is not the correct choice.

### Second Design Implementation

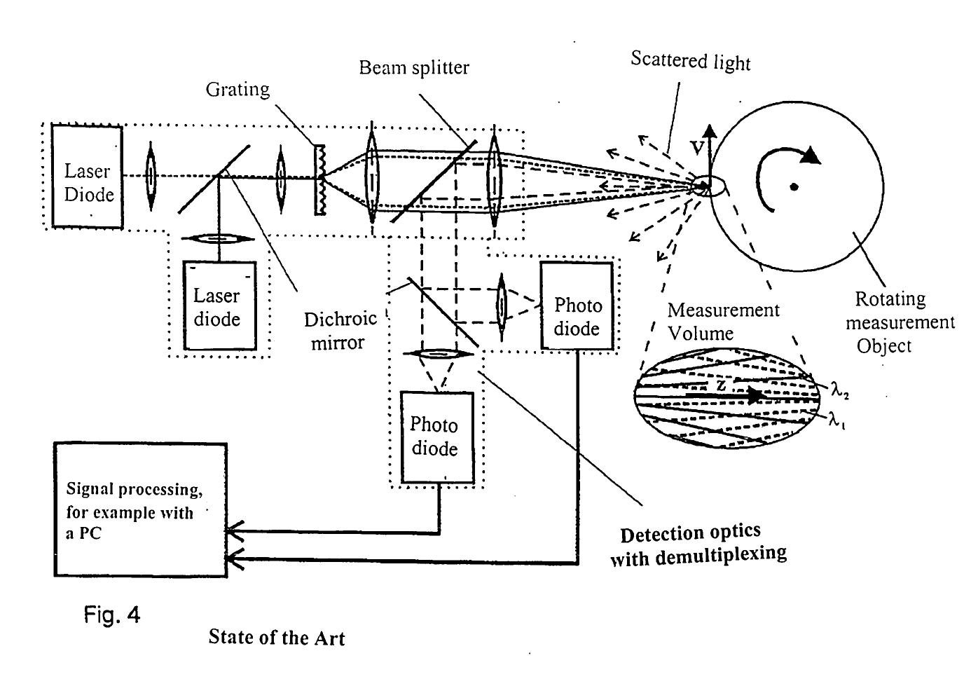

The second design implementation with wavelength multiplexing according to the publications T. Pfister: Untersuchung neuartiger Laser-Doppler-Verfahren zur Positions- and Formvermessung bewegter Festkörperoberflächen, Shaker Verlag, Aachen, 2008 and T. Pfister, L. Büttner, J. Czarske: Laser Doppler profile sensor with sub-micrometre position resolution for velocity and absolute radius measurements of rotating objects, Meas. Sci. Technol. 16, p. 627-641, 2005 shown in FIG. 4 comprises two laser diodes of different emission wavelengths, the light fields of which are superimposed by means of a dichroic mirror and focussed to an optical transmission diffraction grating. The +1^{st} diffraction order and the −1^{st} diffraction order of the grating are each formed by the two partial beams for the two fringe systems of the laser Doppler distance sensor and are mapped to the measurement volume by means of a Keppler telescope. The scattered light is detected in reverse direction and divided back into the two wavelengths λ₁ and λ₂ by a second dichroic mirror and detected separately. By using the grating for beam splitting a higher robustness than in the first design implementation is achieved automatically, as the partial beams always cross automatically in the measurement volume even in case of misadjustment. Moreover, in a fibre optic design, in which the laser light sources and the detectors can be connected to the measurement head by fibre optics as an option, three glass fibres would be sufficient. Moreover, only two optics downstream of the grating for the different wavelengths λ₁ and λ₂ need to be adjusted separately here in order to achieve the required waist positions in the measurement volume. However, this still requires a relatively high effort, which limits the miniaturisation capability and the robustness.

### Third Design Implementation

The third design implementation is a further development of the second design implementation in respect of higher robustness and reduced complexity as described in the publications T. Pfister, L. Büttner, J. Czarske, H. Krain, R. Schodl: Turbo machine tip clearance and vibration measurements using a fibre optic laser Doppler position sensor, Meas. Sci. Technol. 17, p. 1693-1705, 2006, L. Büttner, J. Czarske, H. Knuppertz: Laser Doppler velocity profile sensor with sub-micrometer spatial resolution employing fiber-optics and a diffractive lens, Appl. Opt. 44, No. 12, pp. 2274-2280, 2005 and T. Pfister: Untersuchung neuartiger Laser-Doppler-Verfahren zur Positions- and Formvermessung bewegter Festkörperoberflächen, Shaker Verlag, Aachen, 2008.

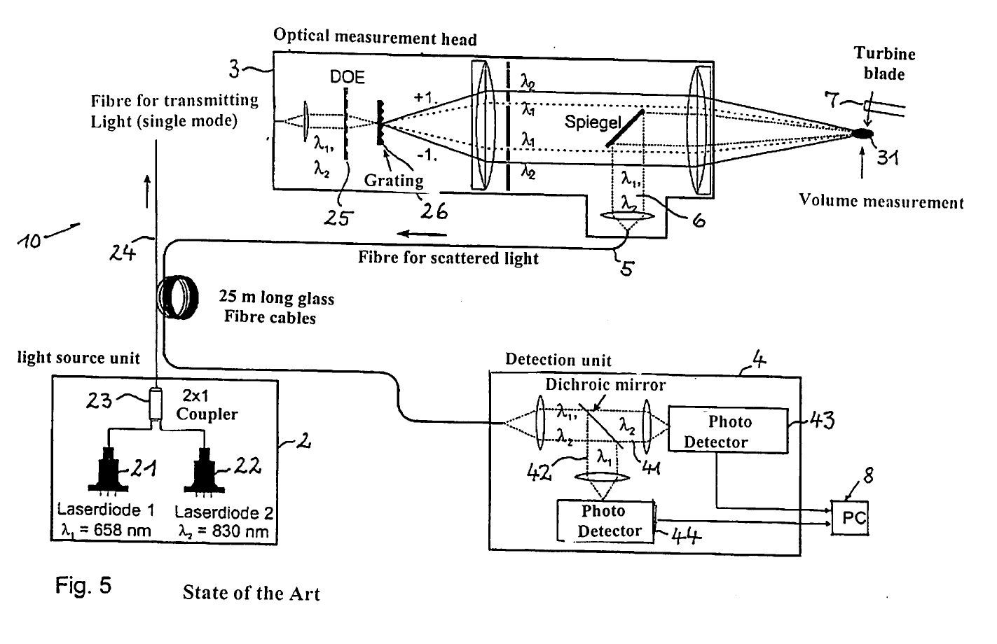

As shown in FIG. 5 this is a modular design of the laser Doppler distance sensor 10, which is divided into three units connected to each other by means of optic fibres: one light source unit 2 with two fibre-coupled, transversal single-mode laser diodes 21, 22 of different wavelengths λ₁ and λ₁, the light fields of which are combined to a single-mode fibre 24 by means of a fibre fusion coupler 23, a merely passive fibre-coupled measurement head 3 and a detection unit 4 for wavelength-based separation and detection of the scattered light 6, with the measurement head 3 and the detection unit 4 being connected to each other by means of a detection fibre 5 for transmitting the scattered light 6.

The special feature is that in contrast to the second design implementation only one transmitting fibre 24 is required in which both wavelengths λ₁ and λ₂ are led to the measurement head 3. This is possible due to the use of a diffractive lens 25 (DOE) the dispersion of which is inherently about 30 times more intense than with refractive lenses according to the publication L. Büttner, J. Czarske, H. Knuppertz: Laser Doppler velocity profile sensor with sub-micrometer spatial resolution employing fiber-optics and a diffractive lens, Appl. Opt. 44, No. 12, pp. 2274-2280, 2005. Hence, the diffractive lens 25 can be used to selectively implement a fixed offset of the beam waists between the two wavelengths λ₁ and λ₁ so that only one transmitting optical system is required, which significantly reduces the adjustment effort. Together with the use of a grating 26 for beam splitting this makes the laser Doppler distance sensor 10 robust and relatively insensitive to vibrations.

Such sensor design has already been successfully tested on a moving solid body 7, on a turbomachine, with the temperature resistance being achieved by means of water cooling in the baseplate of the measurement head 3. However, in practice, this is undesirable or often impossible. Furthermore, the miniaturisation is limited due to the diversity of the optical components and the necessity of two Keppler telescopes. In addition, due to the diversity of the required optical components designing the measurement head for high temperatures without active cooling requires extremely high effort. For example, the design of the Kepler telescope, which may have a very low dispersion only, is very difficult to impossible for high temperatures, as the adhesive layer and the types of glass required for achromatic lenses have a maximum temperature resistance of about 300° C. or 500° C. only.

Overall, however, the third implementation illustrates the advantage provided by the use of diffractive optics and the potential which lies in it.

The mentioned potential of diffractive optics is already used in depth in standard LDV sensors with one measurement channel only, i.e. with one fringe system only. Here, the entire transmitting optical system is integrated in a diffractive micro-optical element comprising a subelement (e.g. a grating) for dividing the laser beam into two partial beams and two downstream deflection elements for subsequent superimposition of the partial beams.

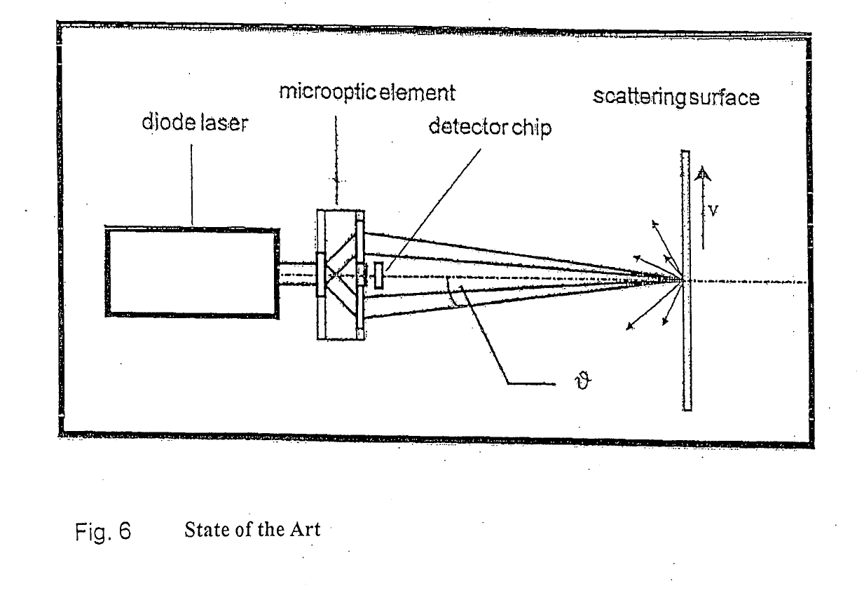

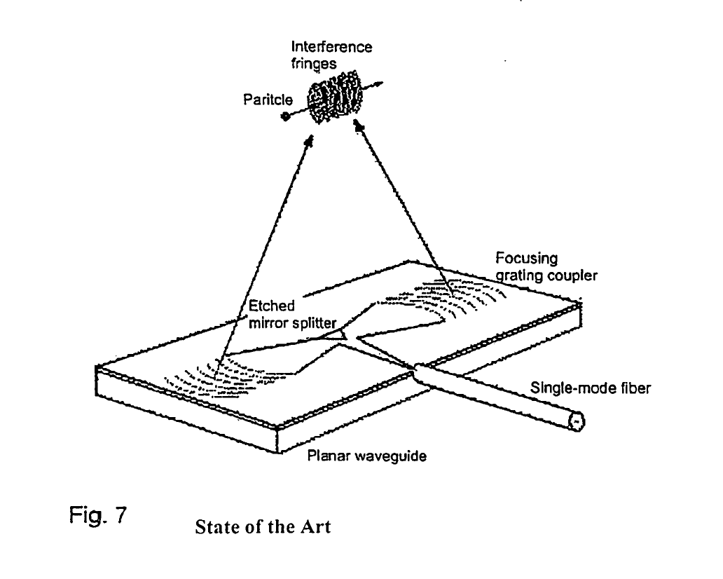

Examples for this are shown in FIGS. 6 and 7 according to the publications W Stork, A. Wagner, C. Kunze: Laser-doppler sensor system for speed and length measurements at moving surfaces, Proc. SPIE, Vol. 4398, 106, 2001 and D. Modarress et al., Measurement Science Enterprise Inc. (Pasadena, Calif., USA) in Kooperation mit VioSense Corporation (2400 Lincoln Ave., Altadena, Calif. 91001, USA).

FIG. 6 shows a miniature laser Doppler velocimeter (LDV) with diffractive micro-optical element and FIG. 7 shows a planar integrated miniature laser Doppler velocimeter (LDV) with a planar integrated micro-beam splitter and with two focussing diffractive elements for beam combination.

The diffractive structures can be applied to different substrates or to one glass substrate only. The front and the back of the glass substrate can be used according to FIG. 6. Moreover, the diffractive structures can also be used to realise focussing elements according to FIG. 7.

However, these diffractive implementations have so far only been used in standard LDV sensors with one measurement channel only, i.e. with one fringe system only, where the only requirement is to realise the correct light path and the correct waist position for a wavelength. In connection with the laser Doppler distance sensor, in which two superimposed fringe systems with different beam waist positions are realised simultaneously (wavelength multiplexing) or timedelayed (time multiplexing) with one optical system, this type of miniaturisation and integration has not be applied yet.

The object of the invention is to provide an apparatus for non-incremental measurement of position and form of moving solid bodies, which is suitably configured in such a way that the apparatus can be miniaturised to such extent that it can be integrated in the housing of turbomachinery in the same manner as capacitive sensors and which enables the laser Doppler distance sensor to withstand temperatures of several hundred degrees Celsius without the requirement of an active cooling.

The object is solved by the characteristics of patent claim 1.

The apparatus for non-incremental position and form measurement of moving solid bodies contains a laser Doppler distance sensor in wavelength multiplexing technique with at least two different wavelengths λ₁ and λ₂ and with a modular,

fibre optic measurement head in its sensor design,
with the sensor design of the laser Doppler distance sensor containing two additional modules, which are connected to the measuring head by means of fibre optics: a light source unit and a detection unit,
with two laser light bundles of different wavelengths λ₁, λ₂ in the light source unit at least being coupled into a glass fibre,
with the bichromatic scattered light in the detection unit being split into the different wavelengths λ₁, λ₂ corresponding to the two measurement channels and subsequently being detected separately by means of two photo detectors, and
with the detection unit being connected to an evaluation unit, in which the signal evaluation is carried out according to the principle of the laser Doppler distance sensor for determination of position, speed and form of the solid body,
with the measurement head according to the characterizing clause of patent claim 1 being configured as a modular passive, fibre optic diffractive miniature measurement head,
which splits the bichromatic laser light bundle emitted from the transmitting fibre in each case into two partial beam bundles into the +1^{st} diffraction order and into the −1^{st} diffraction order using a beam-splitting grating, which partial beam bundles are made to superimpose in a location area by two deflection elements connected downstream, which location area represents the shared measurement volume and that a lens is arranged upstream of the beam-splitting grating, which focuses the laser light bundles emitted from the transmitting fibre in the environment of the measurement volume, with a separation of the beam waists in z direction being caused by the chromatic aberration (dispersion) of the lens in such a way that the beam waist for one wavelength λ₁ is located upstream of the measurement volume and the beam waist for the other wavelength λ₂ is located downstream of the measurement volume.

The lens can be a diffractive lens or a refractive lens, preferably an asphere.

The beam-splitting grating can be a reflection grating or a transmission diffractive grating, which preferably favouringly adjusts the partial beam bundles of the +1^{st} diffraction order and the −1^{st} diffraction order.

The deflection elements can represent diffractive gratings, the grating constant of which is smaller than the grating constant of the beam-splitting grating and which preferably are focussed on formation of partial beam bundles in each case of only one diffraction order (+1⁵¹ or −1^{st}).

The beam-splitting grating and the two deflection elements can be arranged on the front and back of a substrate

The apparatus has the following parameters
laser wavelengths λ₁ and λ₂,
focal distance and dispersion of the lens,
grating periods of the beam-splitting grating,
deflection angle of the deflection elements,
distances from transmitting fibre to lens, lens to grating and grating to deflection elements,
   which are selected and coordinated under a dispersion management in such a way that the following conditions are met at the same time:
The beam waists of the laser beam bundles for the two different wavelengths λ₁ and λ₂ are sufficiently amplified to waist radii w_{0.1} or w_{0.2} in the environment of the measurement volume so that the required measurement range length I_{z,i}=2√2·w_{0,i}/sin θ (i=1.2) is provided by the resulting expansion of the fringe systems in z direction and that a sufficient number of fringes (typically ≧10) is present in the measurement volume, with the angle θ being half the crossing angle between the partial beam bundles crossing in the measurement volume, the beam waist for one wavelength λ₁ is located upstream of the measurement volume and for the other wavelength λ₂ downstream of the measurement volume, preferably at a distance from the crossing point in the measurement volume in each case of around the 1-2 fold Rayleigh length.

Detection of scattered light can be made either in lateral direction or in reverse direction.

The scattered light can be coupled into a detection fibre (multi-mode fibre MMF), which is preferably arranged parallel to the transmitting fibre (single-mode fibre SMF).

For coupling into the detection fibre, a multi-mode fibre MMF, the scattered light can be slightly deflected to one side by means of a deflection element, preferably a wedge prism, which is provided with a hole in order to not disturb the transmitting beams, and then focussed to the end face of the detection fibre receiving the scattered light by means of the lens already existing in the transmitting optical system.

Adjustment of the detection optics can be made in such a way that the radial position of the scattered light spot is adjusted via displacement of the prism by means of a displacement/rotation device in direction of the optical axis (z direction) and that the azimuthal position of the scattered light spot can be changeable by means of the displacement/rotation device via a rotation of the wedge prism, and alternatively adjustment of the detection optics can be achieved via the position (azimuthal, radial) of the detection fibre.

The detection fibre can be located outside the plane spanned by the partial beam bundles of the transmitting light field.

Alternatively, deflection and focussing of the scattered light to the detection fibre can be made by using diffractive elements, which are integrated in the environment of the beam-splitting grating or the deflection elements in at least one substrate, instead of the wedge prism and the individually arranged transmitting lens.

The lens can be integrated in the substrate upstream of the beam-splitting grating.

The beam-splitting grating located in the substrate can be a reflection grating and diverting elements for guidance of the partial beam bundles to the deflection elements can be provided in the substrate.

Instead of a transmitting fibre and a detection fibre a single glass fibre can be used for transmitting light beam bundles and detection of scattered light, which, for example, can be configured as a double-core fibre, through whose SMF core the bichromoatic transmitting light is directed to the measurement head and whose MMF core is used for deflection of the scattered light.

Several or all optical elements of transmitting optics and detection optics can be integrated in one substrate, with additional diverting elements possibly being required and the beam path also being folded.

The effect of the lens can also be integrated in the grating, the diverting elements or the deflection elements in a diffractive or holographic manner.

All optical elements can have a transmittive or reflective design.

The diffractive elements can also have a holographic design.

The integration of the optical elements or the light conduction within the substrate can also be realised by means of a fibre optic system, with the use of photonic crystal structures also being possible.

For all optical elements, preferably lens, wedge prism, and for the substrates of the diffractive elements, preferably beam-splitting grating and deflection elements, temperature-resistant quartz glass can be used.

High-temperature fibres can be used as glass fibres.

The entire measurement head can be designed for high environmental temperatures without an active cooling being required by using quartz glass optics, high-temperature fibres and special materials for the housing, which can be Zerodur, ceramics or high-temperature steel.

Alternatively, the apparatus can be realised by means of time division multiplexing (TDM), with an adaptive optical system simultaneously being integrated in the measurement head.

Hence, the apparatus can be equipped with diffractive grating optics in combination with fibre optics and a special dispersion management unit, which allows easy miniaturisation of the apparatus, with only a very small number of optical components being required. Furthermore, due to its design the apparatus can be designed for high environmental temperatures without an active cooling being required with reasonable effort by using quartz glass optics, high-temperature fibres and special materials for the housing.

For this purpose three diffractive gratings, as already known for standard LDV sensors, are used for the first time in combination with a special dispersion management to realise the laser Doppler distance sensor.

The apparatus according to the invention allows, for the first time, a strongly miniaturised, fibre-coupled design of the laser Doppler sensor, which in addition requires only one fibre optic access path for connection to the outside. Moreover, all optics can be relatively easily manufactured from the quartz glass mentioned above and the adjustment effort is little.

Further features and advantageous embodiments are disclosed in the subordinate claims.

The invention is explained by means of one exemplary embodiment with reference to drawings:

FIG. 1 depicts a diverging (left) fringe system—FIG. 1a—and a converging (right) fringe system—FIG. 1b—with the two fringe systems of different light wavelengths λ1 and λ₂ being superimposed in a measurement area and the measurement of the resulting two Doppler frequencies allowing determination of both, axial position z and the speed (x component) of a typical scattering object,

FIG. 2 depicts a flow chart of the laser Doppler distance sensor for simultaneous determination of the speed vₓ and the position z by means of the measured Doppler frequencies f₁ and f₂ according to the state of the art, left: calibration function q(z),

right: fringe spacings d₁(z) and d₂(z) depending on the position z,

FIG. 3 depicts a design of the laser Doppler distance sensor with frequency multiplexing and fibre optic measurement head, with the detection of scattered light, for reasons of clarity, being shown in forward direction according to the state of the art, although in practice, it takes place in reverse direction in practice,

FIG. 4 depicts a WDM design of the laser Doppler distance sensor with grating and dichroic mirrors according to the state of the art,

FIG. 5 depicts a modular design implementation of the laser Doppler distance sensor with wavelength multiplexing by use of a merely passive, fibre-coupled optical measurement head with diffractive lens (DOE) according to the state of the art,

FIG. 6 depicts a miniature laser Doppler velocimeter (LDV) with diffractive micro-optical element according to the state of the art,

FIG. 7 depicts a planar integrated miniature laser Doppler velocimeter (LDV) with a planar integrated micro beam splitter and with two focussing diffractive elements for beam combination according to the state of the art,

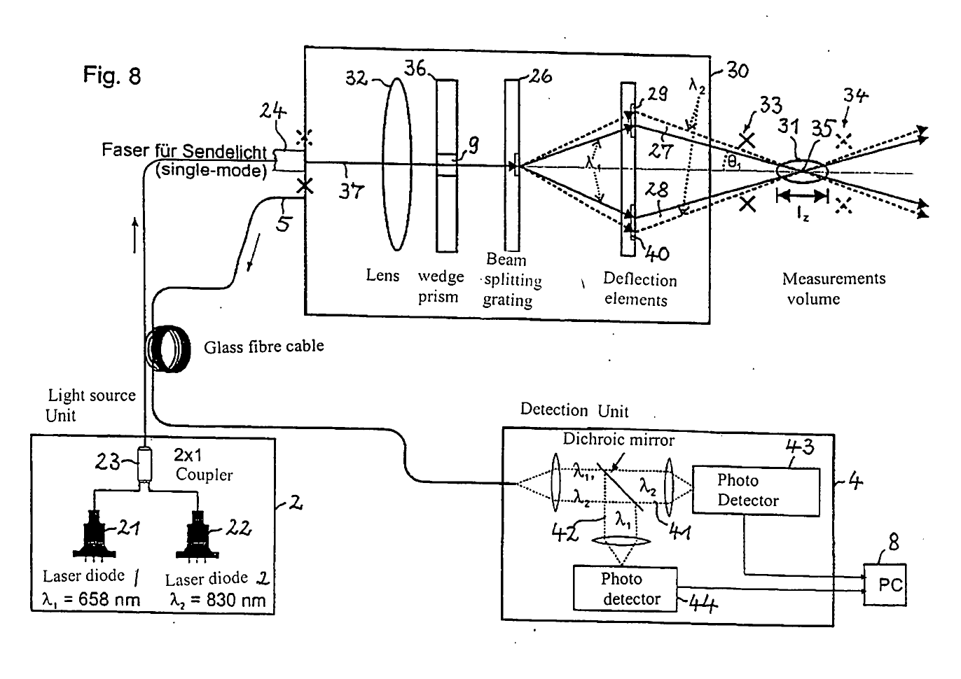

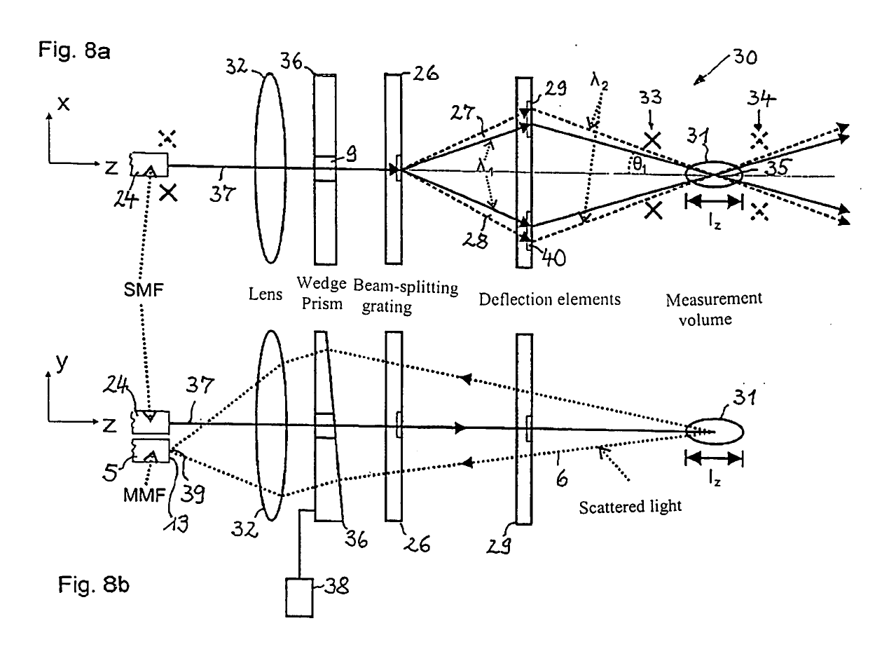

FIG. 8 depicts a fibre-coupled miniature measurement head according to the invention, with

FIG. 8a depicting a beam path of the transmitting light fields for the two different wavelengths λ₁ and λ₂, respectively, whose waist positions are indicated by crosses, and

FIG. 8b depicting a scattered light cone, which is deflected via a prism and focussed to the multi-mode fibre (MMF) through the lens (asphere),

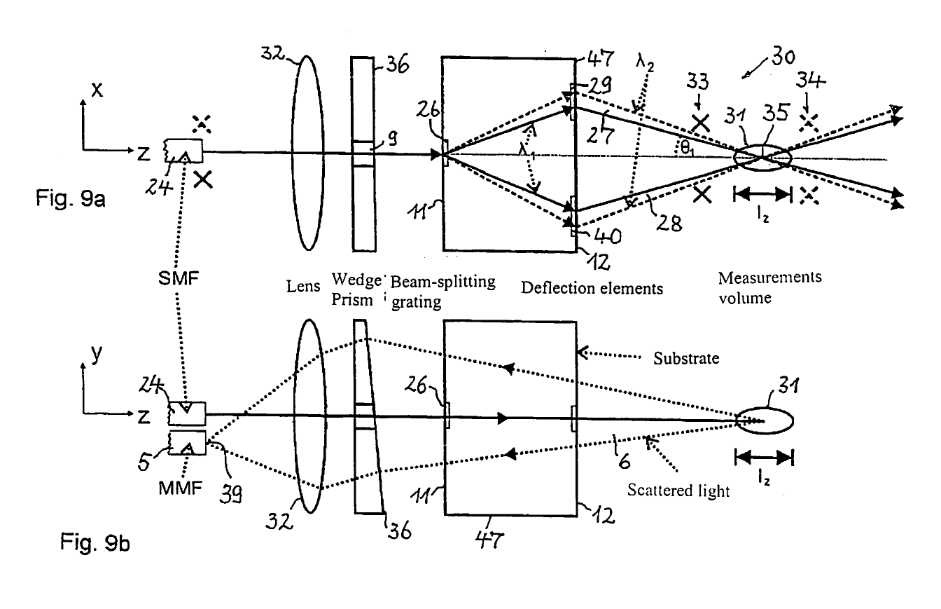

FIG. 9 depicts a fibre-coupled miniature measurement head according to the invention, in which the diffractive optics are integrated in one substrate, with

FIG. 9a depicting a beam path of the transmitting light fields for the two different wavelengths λ₁ and λ₂, respectively, whose waist positions are indicated by crosses, and

FIG. 9b depicting a scattered light cone, which is deflected via a prism and focussed to the multi-mode fibre (MMF) through the lens (asphere),

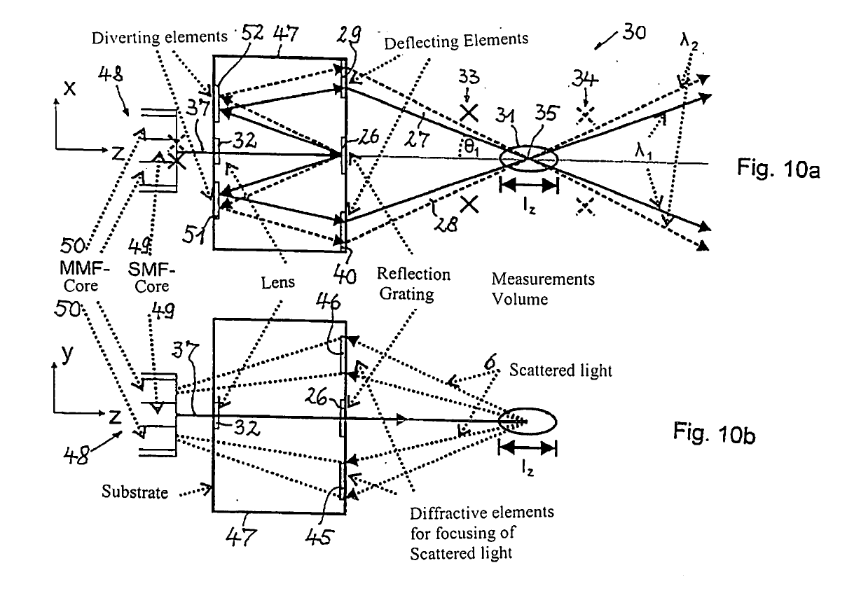

FIG. 10 depicts schematics of a fibre-coupled miniature measurement head according to the invention, in which all optical elements are integrated in one substrate and a double-core fibre is used, with

FIG. 10a depicting a beam path of the transmitting light fields for the two different wavelengths λ₁ and λ₂, respectively, whose waist positions are indicated by crosses, and

FIG. 10b depicting a sectional view rotated by 90° in order to visualise the beam path for the scattered light.

The apparatus 1 shown in FIG. 8 for non-incremental position and measurement of moving solid bodies 7 contains a laser Doppler distance sensor 10 in wavelength multiplexing technique with at least two different wavelengths λ₁ and λ₂ and with a modular, fibre optic measurement head 30 in its sensor design, with the sensor design of the laser Doppler distance sensor 10 containing two additional modules, which are connected to the measuring head 30 by means of fibre optics: a light source unit and a detection unit 4, with two laser light bundles 37 of different wavelengths λ₁, λ₂ in the light source unit 2 at least being coupled into a glass fibre (single-mode fibre—SMF) 24, with the bichromatic scattered light in the detection unit 4 being split into the different wavelengths λ₁, λ₂ corresponding to the two measurement channels 41, 42 and subsequently being detected separately by means of two photo detectors 43, 44, and

with the detection unit 4 being connected to an evaluation unit 8, in which the signal evaluation is carried out according to the principle of the laser Doppler distance sensor 10 for determination of position, speed and form of the solid body 7.

According to the invention, the measurement head is configured as a modular passive, fibre optic diffractive miniature measurement head 30 with a dispersion management,

which splits the bichromatic laser light bundle 37 emitted from the transmitting fibre (SMF) 24 in each case into two partial beam bundles 27, 28 into the +1^{st} diffraction order and into the −1^{st} diffraction order using a beam-splitting grating 26, which partial beam bundles are made to superimpose in a location area by two deflection elements 29, 40 connected downstream, which location area represents the shared measurement volume 31 and that a lens 32 is arranged upstream of the beam-splitting grating 26, which focuses the laser light bundles 37 emitted from the transmitting fibre SMF 24 in the environment of the measurement volume 31, with a separation of the beam waists 33, 34 in z direction being caused by the chromatic aberration (dispersion) of the lens 32 in such a way that the beam waist 33 for one wavelength λ₁ is located upstream of the measurement volume 31 and the beam waist 34 for the other wavelength λ₂ is located downstream of the measurement volume 31.

The lens 32 is a diffractive lens or a refractive lens, preferably an asphere.

The beam-splitting grating 26 is a reflection grating or a transmission diffractive grating, which preferably favouringly adjusts the partial beam bundles of the +1^{st} diffraction order and the −1^{st} diffraction order.

The deflection elements 29, 40 represent diffractive gratings, the grating constant of which is smaller than the grating constant of the beam-splitting grating 26 and which preferably are focussed on formation of partial beam bundles in each case of only one diffraction order (+1^{st} or −1^{st}).

The beam-splitting grating 26 and the two deflection elements 29, 40 can be arranged on the front 11 and back 12 of a substrate 47.

In the apparatus, the following parameters
laser wavelengths λ₁ and λ₂,
focal distance and dispersion of the diffractive lens 32,
grating periods of the beam-splitting grating 26,
deflection angle of the deflection elements 29, 40,
distances from transmitting fibre 24 to lens 32, lens 32 to grating 26 and grating 26 to deflection elements 29, 40,
   are selected and coordinated under a dispersion management in such a way that the following conditions are met at the same time:
The beam waists 33, 34 of the laser beam bundles 27, 28 for the two different wavelengths λ₁ and λ₂ are sufficiently amplified to waist radii w_{0,1} or w_{0,2} in the environment of the measurement volume 31 so that the required measurement range length I_{z,i}=2√2·w_{0,i}/sin θ (i=1.2) is provided by the resulting expansion of the fringe systems in z direction and that a sufficient number of fringes (typically ≧10) is present in the measurement volume 31, with the angle θ being half the crossing angle between the partial beam bundles 27, 28 crossing in the measurement volume 31,
the beam waist 33 for one wavelength λ₁ is located upstream of the measurement volume 31 and the beam waist 34 for the other wavelength λ₂ down-stream of the measurement volume 31, preferably at a distance from the crossing point 35 in the measurement volume 31 in each case of around the 1-2 fold Rayleigh length.

Detection of scattered light can be made either in lateral direction or in reverse direction.

The scattered light 6 is coupled into a detection fibre (multi-mode fibre MMF) 5, which is preferably arranged parallel to the single-mode fibre SMF 24.

For coupling into the detection fibre 5, the scattered light 6 can be slightly deflected to one side by means of a deflection element 36, preferably a wedge prism, which is provided with a centre hole 9 in order to not disturb the transmitting beams 37, and then focussed to the end face 13 of the detection fibre 5 receiving the scattered light by means of the lens 32 already existing in the trans-miffing optical system.

Adjustment of the detection optics 36, 32, 5 can be made in such a way that the radial position of a scattered light spot 39 is adjusted via displacement of the prism 36 by means of a displacement/rotation device 38 in direction of the optical axis (z direction), with the azimuthal position of the scattered light spot 39 being changeable by means of the displacement/rotation device 38 via a rotation of the wedge prism 36, and alternatively adjustment of the detection optics 36, 32, 5 can be achieved via the position (azimuthal, radial) of the detection fibre (MMF) 5.

The detection fibre 5 is located outside the plane spanned by the partial beam bundles 27, 28 of the transmitting light field.

Alternatively, deflection and focussing of the scattered light 6 to the detection fibre 5 can be made by using diffractive elements 45, 46, which are integrated in the environment of the beam-splitting grating 26 or the deflection elements 29, 40 in at least one substrate 47, instead of the wedge prism 36 and the individually arranged transmitting lens 32.

The lens 32 can also be integrated in the substrate 47.

The beam-splitting grating 26 located in the substrate 47 is a reflection grating and diverting elements 51, 52 for guidance of the partial beam bundles 27, 28 to the deflection elements 29, 40 are provided in the substrate 47.

Instead of a transmitting fibre SMF 24 and a detection fibre, multi-mode fibre MMF, 5 a single glass fibre 48 can be used for transmitting light beam bundles 37 and detection of scattered light, which, for example, is configured as a double-core fibre, through whose SMF core 49 the bichromoatic transmitting light bundle 37 is directed to the measurement head 30 and whose MMF core 50 is used for deflection of the scattered light 6.

The effect of the lens 32 can also be integrated in the grating 26, the diverting elements 51, 52 or the deflection elements 29, 40 in a diffractive or holographic manner.

All optical elements can have a transmittive or reflective design.

The diffractive elements 45, 46 can also have a holographic design.

The integration of the optical elements or the light conduction within the substrate 47 can also be realised by means of a fibre optic system, for which photonic crystal structures can also be used.

For all optical elements, preferably lens 32, wedge prism 36, and for the substrates 47 of the diffractive elements, preferably beam-splitting grating 26 and deflection elements 29, 40, temperature-resistant quartz glass can be used.

High-temperature fibres can be used as glass fibres 48.

The entire measurement head 30 can be designed for high environmental temperatures without an active cooling being required by using quartz glass optics, high-temperature fibres and special materials for the housing, such as Zerodur, ceramics or high-temperature steel.

Alternatively, the apparatus 1 can be realised by means of time division multiplexing (TDM), with an adaptive optical system simultaneously being integrated in the measurement head 30.

According to the invention, the measurement head 30 shown in FIG. 8, 8a, 8b of the laser Doppler distance sensor 10 is no longer constructed, as before, by means of two telescopes according to FIG. 5, but instead only one single dispersive lens 32 arranged upstream of the grating 26 is provided, which is responsible for focussing the laser beam bundles 27, 28 and the waist separation and the beam combination downstream of the beam-splitting grating 26 is made by means of two diffractive deflection elements 29, 40 according FIG. 8. Hence, the transmitting optical system now consists of three components only: the lens 32, the beam-splitting grating 26 for beam splitting and one or two diffractive elements 29, 40 for beam combination.

The functionality of the design of the fibre coupled miniature measurement head 30 according to the invention from FIG. 8, 8a, 8b can be described as follows: The superimposed beam waists 33, 34 of the two laser wavelengths λ₁ and λ₂ at the fibre end of the single-mode fibre—SMF—24 at the measurement head 30 are mapped to the measurement volume 31 by means of a specially selected dispersive lens 32, for example, an asphere. The light fields of the different wavelengths λ₁ and λ₂ are split between the dispersive lens 32 and the measurement volume 31 by means of the beam-splitting grating 26 (with the 1^{st} diffraction order and the −1^{st} diffraction order being used) and made to cross in the measurement volume centre by means of one deflection element 29, 40 for each partial beam bundle 27, 28 according to FIG. 8a. The deflection elements 29, 40 can be implemented as gratings, whose grating period must be smaller than the grating period of the beam-splitting grating 26.

The dispersion management according to the invention provides that the parameters
laser wavelengths λ₁ and λ₂,
focal distance and dispersion of the lens 32,
dispersion (wavelength dependence of the focal distance) of the lens 32,
grating periods of the beam-splitting grating 26,
deflection angle of the deflection elements 29, 40,
distances from transmitting fibre SMF 24 to lens 32, lens 32 to grating 26 and grating 26 to deflection elements 29, 40,
   are selected and coordinated in such a way that the following conditions are met at the same time:
The beam waists 33, 34 of the laser beam bundles 27, 28 for the two different wavelengths λ₁ and λ₂ are sufficiently amplified to waist radii w_{0,1} or w_{0,2} in the environment of the measurement volume 31 so that the required measurement range length I_{z,i}=2√2·w_{0,i}/sin θ (i=1.2) is provided by the resulting expansion of the fringe systems in z direction and that a sufficient number of fringes (typically ≧10) is present in the measurement volume 31.
The beam waist 33 for one wavelength λ1 is located upstream of the measurement volume 31 and for the other wavelength λ2 downstream of the measurement volume 31, preferably at a distance from the crossing point 35 in the measurement volume in each case of around the 1-2 fold Rayleigh length.

The chromatic aberration of the lens 32 is used specifically for the different positioning of the beam waists 33, 34 for the two laser wavelengths λ1 and λ2 used upstream and downstream, respectively of their crossing point 35 in the measurement volume 31 and enhanced by the amplification in the mapping. Detection of the scattered light can be made as shown in FIG. 8b. Here, the same lens 32 is used for detection of the scattered light 6 from the solid body 7 in reverse direction and for focussing on the detection fibre 5 (multi-mode fibre—MMF—), which also maps the transmitting light 37 to the measurement volume 31. Due to the detection fibre (MMF) 5 not being positioned on the optical axis but slightly displaced next to the transmitting fibre (single-mode fibre—SMF—) 24 a special wedge prism 36 is provided in the measurement head 30 between the lens 32 and the beam-splitting grating 26 for displacement of the spot 39 of the scattered light 6 to the multi-mode detection fibre 5. Furthermore, the wedge prism 36 is provided with a centre hole 9 so that the transmitting light field 37 is not impaired. By displacing the prism 36 towards the optical axis (z direction) the radial position of the scattered light spot 39 can be adjusted. The azimuthal position of the scattered light spot 39 can be changed, for example, by means of the displacement/rotation device 38 via a rotation of the wedge prism 38. Alternatively adjustment of the detection optics can be achieved via the position (azimuthal, radial) of the detection fibre (MMF) 5. Preferably, the detection fibre 5 is located outside the plane spanned by the partial beam bundles 27, 28 of the transmitting light field. This prevents that direct reflexes at the solid body 7 not having any informational content are coupled in to the detection fibre 5.

Alternatively, the scattered light optical system can be realised by focussing the scattered light 6 by means of diffractive elements 45, 46 which can be integrated in the substrate 47 for the beam-splitting grating 26 or for the deflection elements 29, 40, as shown in FIG. 10a, 10b.

The lens 32 and the wedge prism 36 as well as the beam-splitting grating 26 and the deflection elements 29, 40 and the glass fibres 24, 5, 48 can be manufactured from temperature-resistant quartz glass, so that operation at high temperatures is possible. Hence, this measurement head design can be designed for high environmental temperatures without an active cooling being required with reasonable effort by using quartz glass optics, high-temperature fibres and special materials for the housing.

Moreover, the measurement head 30 of the laser Doppler distance sensor 10 is easy to miniaturise, as only a small number of optical components is required.

In FIGS. 9a and 9b the number of components and the mechanical effort is reduced further in another measurement head 30 according to the invention by arranging the two diffractive elements: beam-splitting grating 26 and deflection elements 29, on the front 11 and back 12 of a substrate 47 which results in the elements automatically being perfectly aligned with each other.

In a further measurement head 30 several or all optical elements can be integrated in one substrate 47, and the optical beam path can also be folded, possibly by using additional diverting elements 51, 52 according to FIG. 10a, 10b. In general, all optical elements can have a transmittive or reflective design. As an example, in FIG. 10a,10b the beam-splitting grating 26 is shown as a reflection grating in contrast to FIG. 8. According to FIG. 10a, 10b, the lens 32 can also be implemented as diffractive lens. Alternatively, the lens effect can also be integrated in the grating 26, the diverting elements 51, 52 or the deflection elements 29, 40 in a diffractive or holographic manner, similar to as shown in FIG. 7. Furthermore, instead of two different glass fibres 24, 5 for transmitting light 38 and detection of scattered light 6, a single glass fibre 48 can be used, which can be a double-core fibre as shown in FIG. 10a,10b.

The progress beyond the state of the art consists in that the measurement head 30 according to the invention can be manufactured in a very compact design by using only few optical components. Furthermore, the use of high-temperature fibres and optical components from temperature-resistant glasses (quartz glass) allows measurements at very high temperatures without active cooling. Moreover, for adjustment of the measurement 30 head it is principally sufficient to adjust the distance between the fibre end of the transmitting fibre 24 and the lens 32, which allows simultaneous displacement of the beam waists 33, 34 of the two wavelengths around the crossing point 35 of the partial beam bundles 27, 28. Adjustment of the wedge prism 36 is only required once during assembly of the measurement head 30. The fact that the miniaturised measurement head 30 generally requires only one device for adjustment makes this apparatus 1 insensitive to vibrations.

These characteristics make the fibre-coupled, compact and merely optical passive measurement head 30 highly suitable for use for measurement of vibrations of the blades 7 as well as tip clearance measurements in turbomachinery. Due to the high miniaturisation potential the necessary compactness of the sensor for use in turbomachinery is given. As very high temperatures of up to more than 1000° C. occur in turbomachinery, the measurement head 30 must withstand these. This has been implemented in the apparatus by means of high-temperature fibres and temperature-resistant optics. Due to the spatial separation of the transmitting unit 2 and the detection unit 4 to the measurement head 30 by maintaining the modular implementation according to FIG. 5 active optical components, such as laser diodes and photodetectors can also be decoupled from the rough environmental impacts at turbomachinery.

In summary, the apparatus 1 according to the invention provides the following advantages over the state of the art:
The merely passive, fibre optic measurement head 30 can be built as a dispersion management miniature measurement head in an extremely compact design, as apart from the glass fibres 24, 5, 48 including detection optics only a maximum of four optical elements is required, which in addition can be fully or partly integrated in a substrate 47.
Furthermore, the adjustment effort is extremely little, especially if the elements are integrated in a substrate 47. This makes the sensor design extremely robust.
Only one lens 32 is required, for which a single lens (singlet) is sufficient (e.g. an asphere). In particular, no achromatic lenses are needed.
All optical elements (lens, wedge prism, diffractive elements and glass fibres) can be manufactured from quartz glass without any problems, which generally has a temperature resistance of beyond 1000° C. Hence, the apparatus 1 according to the invention allows, for the first time, a design of the measurement head 30 of the laser Doppler distance sensor 10 for such high temperatures up to more than 1000° C. without active cooling, which was generally not possible with the previously known measurement head designs. The optical fibres used can be high-temperature fibres with special temperature-resistant metal coating. A stable design of the housing for these high temperatures is only possible by using special steels, Zerodur or ceramics.
Another advantage of the miniature measurement head 30 according to the invention is that the transmitting fibre 24 and the detection fibre 5 run parallel so that they can both be run in one tube and thus (in contrast to the design from FIG. 5) only one access cable to the measurement head 30 is required.

The advantage of the apparatus 1 according to the invention over previous implementations of a laser Doppler distance sensor 1 lies in the very simple design with only few optical components which reveals a high miniaturisation potential. Moreover, the apparatus 1 allows to relatively easy design the laser Doppler distance sensor 1 for high temperatures as occurring, for example, in turbomachinery.

### REFERENCE LIST

1 apparatus
2 light source unit
3 typical measurement head
4 detection unit
5 detection fibre
6 scattered light
7 solid body
8 evaluation unit
9 centre hole
10 typical laser Doppler distance sensor
11 front
12 back
13 end face
21 first laser diode
22 second laser diode
23 fibre fusion coupler
24 transmitting fibre
25 diffractive lens
26 beam-splitting grating
27 first partial beam bundle
28 second partial beam bundle
29 first deflection element
30 measurement head according to the invention
31 measurement volume
32 dispersive lens
33 first beam waist
34 second beam waist
35 crossing point
36 deflection element
37 transmitting beam bundle
38 displacement/rotation device
39 scattered light spot
40 second deflection element
41 first measurement channel
42 second measurement channel
43 first photodetector
44 second photodetector
45 first diffractive element
46 second diffractive element
47 substrate
48 glass fibre
49 SMF core
50 MMF core
51 first diverting element
52 second diverting element

1. Apparatus (1) for non-incremental position and form measurement of moving solid bodies (7), containing a laser Doppler distance sensor (10) in wave-length multiplexing technique with at least two different wavelengths (λ1, λ2) and with a modular fibre optic measurement head in its sensor design, with the sensor design of the laser Doppler distance sensor (10) containing two additional modules, which are connected to the measuring head by means of fibre optics: a light source unit (2) and a detection unit (4),
with two laser light bundles (37) of different wavelengths (λ1, λ2) in the light source unit (2) at least being coupled into a glass fibre (24), with the bichromatic scattered light in the detection unit (4) being split into the different wavelengths (λ1, λ2) corresponding to the two measurement channels (41, 42) and subsequently being detected separately by means of two photo detectors (43, 44), and with the detection unit (4) being connected to an evaluation unit (8), in which the signal evaluation is carried out according to the principle of the laser Doppler distance sensor (10) for determination of position, speed and form of the solid body (7), characterized in that,
the measurement head is configured as a modular passive, fibre optic diffractive miniature measurement head (30),
which splits the bichromatic laser light bundle (37) emitted from the transmitting fibre (24) in each case into two partial beam bundles (27, 28) into the +1st diffraction order and into the −1st diffraction order using a beam-splitting grating (26), which partial beam bundles are made to superimpose in a location area by two deflection elements (29, 40) connected downstream, which location area represents the shared measurement volume (31) and that a lens (32) is arranged upstream of the beam-splitting grating (26), which
focuses the laser light bundles (37) emitted from the transmitting fibre (24) in the environment of the measurement volume (31), with a separation of the beam waists (33, 34) in z direction being caused by the dispersion of the lens (32) in such a way that the beam waist (33) for one wavelength (λ1) λ1 is located upstream of the measurement volume (31) and the beam waist (34) for the other wavelength (λ2) is located downstream of the measurement volume (31).

2. Apparatus according to claim 1, characterized in that, the lens (32) is a diffractive lens or a refractive lens, preferably an asphere.

3. Apparatus according to
claim 2,
characterized in that,
the beam-splitting grating (26) is a reflection grating or a transmission diffractive grating, which preferably favouringly adjusts the partial beam bundles of the +1 diffraction order and the −1′ diffreaction order.

4. Apparatus according to
claim 1, characterized in that,
the deflection elements (29, 40) represent diffractive gratings, the grating constant of which is smaller than the grating constant of the beam-splitting grating (26) and which preferably is focussed on formation of only one diffraction order (+1st or −1st) in each case.

5. Apparatus according to claim 1,
characterized in that,
the beam-splitting grating (26) and the two deflection elements (29, 40) are arranged on the front (11) and back (12) of a substrate (47).

6. Apparatus according to claim 1,
characterized in that,
the following parameters
laser wavelengths (λ1, λ2),
focal distance and dispersion of the diffractive lens (32),
grating periods of the beam-splitting grating (26),
deflection angle of the deflection elements (29, 40),
distances from transmitting fibre (24) to lens (32), lens (32) to grating (26) and grating (26) to deflection elements (29,40) are selected and coordinated under a dispersion management in such a way that the following conditions are met at the same time:
The beam waists (33, 34) of the laser beam bundles (27, 28) for the two different wavelengths (λ1, λ2) are sufficiently amplified to waist radii (w0,1 or w0,2) in the environment of the measurement volume (31), so that the required measurement range length Iz,i=2√2·w0,i/sin θ (i=1, 2) is provided by the resulting expansion of the fringe systems in z direction and that a sufficient number of fringes (typically >10 or even) is present in the measurement volume (31),
The beam waist (33) for one wavelength (A1) is located upstream of the measurement volume (31) and the beam waist (34) for the other wavelength (λ2) downstream of the measurement volume (31), preferably at a distance from the crossing point (35) in the measurement volume in each case of around the 1-2 fold Rayleigh length.

7. Apparatus according to claim 1,
characterized in that,
detection of scattered light is made either in lateral direction or in reverse direction.

8. Apparatus according to claim 1,
characterized in that,
that the scattered light (6) is coupled into a detection fibre (5), which is preferably arranged parallel to the transmitting fibre (24).

9. Apparatus according to claim 8,
characterized in that,
for coupling into the detection fibre (5), the scattered light is slightly deflected to one side by means of a deflection element (36), preferably a wedge prism, which is provided with a centre hole in order to not disturb the transmitting beams (37), and then focussed to the entry (13) of the detection fibre (5) by means of the lens (32) already existing in the transmitting optical system.

10. Apparatus according to claim 1, characterized in that, adjustment of the detection optics (36, 32, 5) is made in such a way that the radial position of a scattered light spot (39) is adjusted via displacement of the prism (36) by means of a displacement/rotation device (38) in direction of the optical axis, z direction, with the azimuthal position of the scattered light spot (39) being changeable by means of the displacement/rotation device (38) via a rotation of the wedge prism (36), and alternatively adjustment of the detection optics (36, 32, 5) can be achieved via the azimuthal and radial position of the detection fibre (5).

11. Apparatus according to
claim 10, characterized in that,
the detection fibre (5) is located outside the plane spanned by the partial beam bundles (27, 28) of the transmitting light field.

12. Apparatus according to claim 1, characterized in that, alternatively, deflection and focussing of the scattered light (6) to the detection fibre (5) is made by using diffractive elements (45, 46), which are integrated in the environment of the beam-splitting grating (26) or the deflection elements (29, 40) in at least one substrate (47), instead of the wedge prism (36) and the individually arranged transmitting lens (32).

13. Apparatus according to claim 1,
characterized in that,
the lens (32) is integrated in the substrate (47) upstream of the beam-splitting grating (26).

14. Apparatus according to claim 1, characterized in that, the beam-splitting grating (26) located in the substrate is a reflection grating and diverting elements (51, 52) for guidance of the partial beam bundles (27, 28) to the deflection elements (29, 40) are provided in the substrate (47).

15. Apparatus according to claim 1, characterized in that, instead of a transmitting fibre (24) and a detection fibre (5) a single glass fibre (48) only is be used for transmitting light beam bundles (37) and detection of scattered light, which, for example, is configured as a double-core fibre, through whose SMF core (49) the bichromatic transmitting light (37) is directed to the measurement head (30) and whose MMF core (50) is used for deflection of the scattered light (6).

16. Apparatus according to claim 1,
characterized in that,
several or all optical elements of transmitting optics and detection optics are integrated in one substrate (47), with additional diverting elements (51, 52) possibly being required and it also being possible to fold the beam path.

17. Apparatus according to claim 1,
characterized in that,
the effect of the lens (32) is integrated in the grating (26), the diverting elements (51, 52) or the deflection elements (29, 40) in a diffractive or holographic manner.

18. Apparatus according to claim 1,
characterized in that,
all optical elements have a transmittive or reflective design.

19. Apparatus according to claim 12, characterized in that, the diffractive elements (45, 46) also have a holographic design.

20. Apparatus according to claim 12, characterized in that,
the integration of the optical elements or the light conduction within the substrate (47) is also realised by means of a fibre optic system, with photonic crystal structures also being used.

21. Apparatus according to claim 12, characterized in that,
for all optical elements, preferably lens (32), wedge prism (36), and for the substrates (47) of the diffractive elements, in particular the beam-splitting grating (26) and deflection elements (29, 40), temperature-resistant quartz glass is used.

22. Apparatus according to claim 12,
characterized in that,
high-temperature fibres are used as glass fibres (24, 5, 48).

23. Apparatus according to claim 12,
characterized in that,
the entire measurement head (30) is designed for high environmental temperatures without an active cooling being required by using quartz glass optics, high-temperature fibres and special materials for the housing, which is manufactured from Zerodur, ceramics or high-temperature steel.

24. Apparatus according to claim 1,
characterized in that,
alternatively, the apparatus (1) is realised by means of time division multiplexing (TDM), with an adaptive optical system simultaneously being integrated in the measurement head (30).
